(19) United States
(12) Patent Application Publication
(10) Pub. No.: US 2012/0169477 A1
(43) Pub. Date: Jul. 5, 2012

(54) COMMUNICATIONS SYSTEM AND METHOD OF COMMUNICATING DISPLAY INFORMATION, AND ELECTRONIC SHELF LABEL SYSTEM USING THE SAME

(75) Inventors: Jeong Su SEO, Seoul (KR); Song On Lee, Suwon (KR); Tae Ha Lee, Seongnam (KR); Dong Hyun Kim, Hwaseong (KR); Hyun Hak Kim, Osan (KR); Chang Soo Lim, Seoul (KR); Ju Hyung Kim, Seoul (KR)

(73) Assignee: SAMSUNG ELECTRO-MECHANICS CO., LTD.

(21) Appl. No.: 13/340,161

(22) Filed: Dec. 29, 2011

(30) Foreign Application Priority Data
Dec. 30, 2010 (KR) 10-2010-0139023

(51) Int. Cl. G06K 7/01

(52) U.S. Cl. 340/10.6

(57) ABSTRACT

There are provided a communications system and a method for more efficiently communicating display information in transmitting large-capacity data, such as graphics data, between communication nodes, and an electronic shelf label system using the same. The communications system communicating display information includes a first communications device transmitting display information and a second communications device having a display unit displaying the display information.

### CROSS-REFERENCE TO RELATED APPLICATIONS

This application claims the priority of Korean Patent Application No. 10-2010-0139023 filed on Dec. 30, 2010, in the Korean Intellectual Property Office, the disclosure of which is incorporated herein by reference.

### BACKGROUND OF THE INVENTION

1. Field of the Invention

The present invention relates to a communications system and a communications method, and more particularly, to a communications system and a method of efficiently communicating display information in the transmission of large-capacity data, for example, graphics data, between communication nodes as in an electronic shelf label system, and an electronic shelf label system using the same.

2. Description of the Related Art

The demand for and use of information devices has been gradually increased both domestically and internationally. In particular, the amount of information processed in these information devices has been continuously increased according to user demand.

Therefore, a display device according to the segment type of display device in the related art has been replaced with a graphics device due to limitations in an amount of information able to be processed and the design thereof.

On the other hand, a graphics type device may process a large amount of information and may variously implement information types that may be displayed to customers.

However, since the graphics device type has large data throughput, it increase an operating rate of a device and traffic within a network to make a system unstable or delay a transmission.

### SUMMARY OF THE INVENTION

An aspect of the present invention provides a communications system and a method of efficiently communicating display information in transmitting large-capacity data, for example, graphics data, between communication nodes, and an electronic shelf label system using the same.

According to an aspect of the present invention, there is provided a communications system for communicating display information, the communications system including: a first communications device transmitting display information; and

a second communications device having a display unit displaying the display information, wherein the display information includes display data and layout information as to where the display data is disposed, and the first communications device transmits the layout information to the second communications device during an initial communication and transmits changed display data among the display data to the second communications device during subsequent communications after the initial communication.

The layout information may include coordinate information displaying the display data.

The layout information may further include at least one of a display format, fix/change or not, a font type, a font color, and a font size of the display data.

The first communications device is a server or a sync node device of an electronic shelf label system, and the second communications device is a price display of the electronic shelf label system.

According to an aspect of the present invention, there is provided a method for communicating display information including display data and layout information as to where the display data is disposed, the method including: transmitting layout information and initial data of display data from a first communications device to a second communications device during an initial communication; updating a display unit by allowing the second communications device to use the layout information and the initial data; transmitting changed display data among the display data to the second communications device by the first communications device; and updating the display unit by allowing the second communications device to reflect the changed display data.

According to another aspect of the present invention, there is provided an electronic shelf label system including a server transmitting display information; a sync node device receiving the display information from the server and determining whether the display information is display information to be transmitted to a subordinate node thereof; and an electronic price display receiving the display information transmitted thereto as a designation from the sync node device, wherein the display information includes display data and layout information as to where the display data is disposed, and the server and the sync node device transmit the layout information during an initial communication and transmit changed display data among the display data during subsequent communications after the initial communication.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing components of a communications system communicating display information and signal flows between the components according to an exemplary embodiment of the present invention;

FIG. 2 shows an example of a screen displayed on a price display in a communications system communicating display information according to an exemplary embodiment of the present invention;

FIG. 3 shows an example of layout information displayed on the price display in the communications system communicating display information according to the exemplary embodiment of the present invention; and

FIG. 4 shows an example of display data displayed on the price display in the communications system communicating display information according to the exemplary embodiment of the present invention.

### DETAILED DESCRIPTION OF THE PREFERRED EMBODIMENT

Hereinafter, exemplary embodiments of the present invention will be described in detail with reference to the accompanying drawings. However, the exemplary embodiments of the present invention may be modified in various forms and the scope of the present invention is not limited to the exemplary embodiments described below. Exemplary embodiments of the present invention are provided so that those skilled in the art may more completely understand the present invention. Accordingly, shapes and sizes of elements in the drawings may be exaggerated for a clear description thereof.

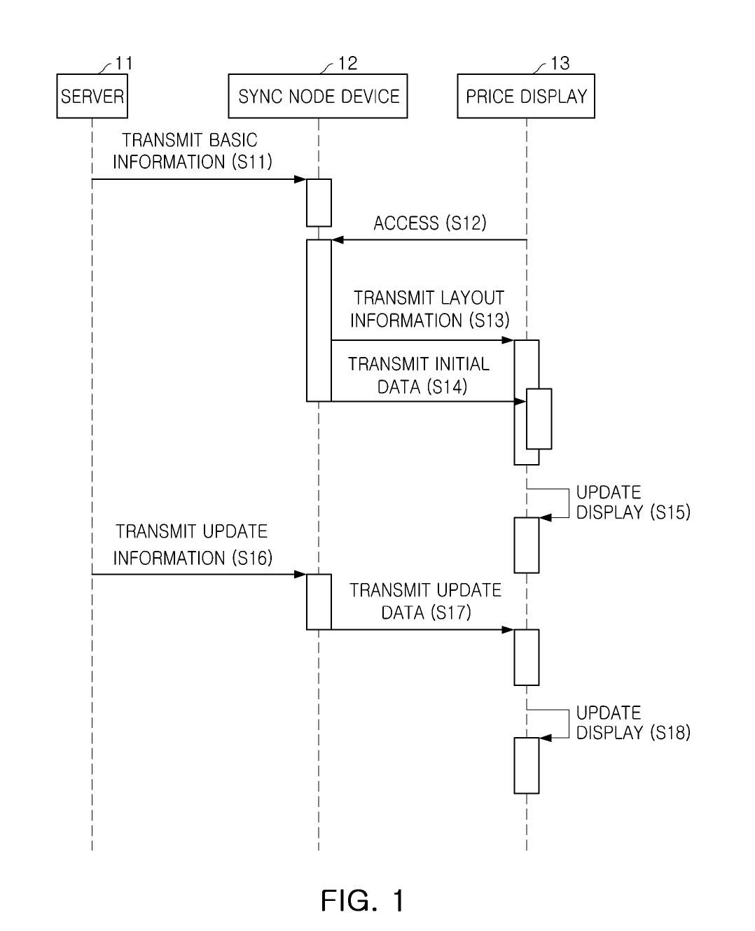

FIG. 1 is a diagram showing components of a communications system communicating display information and signal flows between components according to an exemplary embodiment of the present invention.

As shown in FIG. 1, a communications system communicating display information according to an exemplary embodiment of the present invention may be configured to include a plurality of communications devices 11, 12, and 13. The device having a display unit receiving and displaying display information is referred to as a second communications device and the devices 11 and 12 transmitting display information to a second communications device are referred to as a first communications device.

In particular, the communications system communicating display information shown in FIG. 1 may be an electronic shelf label (ESL) system including a server 11, a sync node device 12, and price displays 13.

In the electronic shelf label system, the server 11 and the sync node device 12 may correspond to the first communications device transmitting the display information and the price displays 13 including the display unit and visually displaying the display information may correspond to the second communications device.

In the above-mentioned system, the server 11 may transmit display information to the sync node (S11). The display information may include display data including information on directly and visually displayed data (for example, characters, figures (prices, weights)) and layout information as to where the display data is disposed on a display unit.

The sync node device 12 receiving the display information from the server 11 may transmit the display information to one of the price displays 13 connected to the sync node device 12, which is a designation of the received display information (S12).

As described above, the display information may include the layout information and the display data. When the operation of the price display 13 starts, the initial communication is made after an access to the sync node device 12 is completed. During the initial communication process, the sync node device 12 transmits the layout information (S13) and then, transmits the display data recorded in each layout (S15).

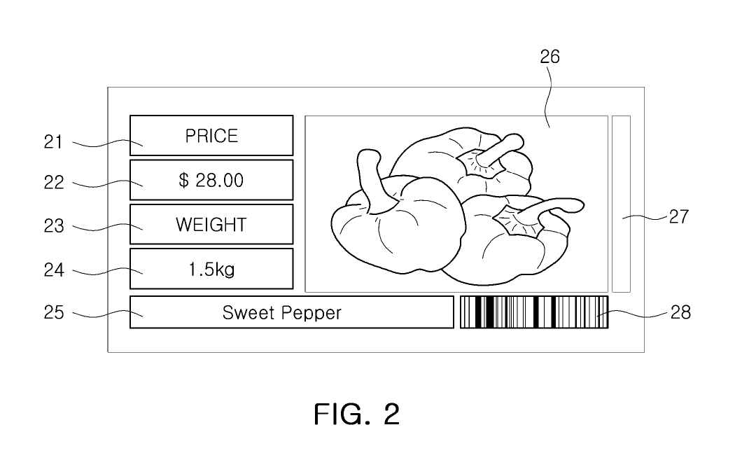

FIG. 2 shows an example of a screen displayed on the price display 13. As shown in FIG. 2, various types of data have various arrangement shapes in the display unit of the price display 13.

In order to display the various display information, a position (coordinates) where each display data is to be displayed, and a style of lettering representing the display data, that is, a font color, a font size, or the like, should be determined.

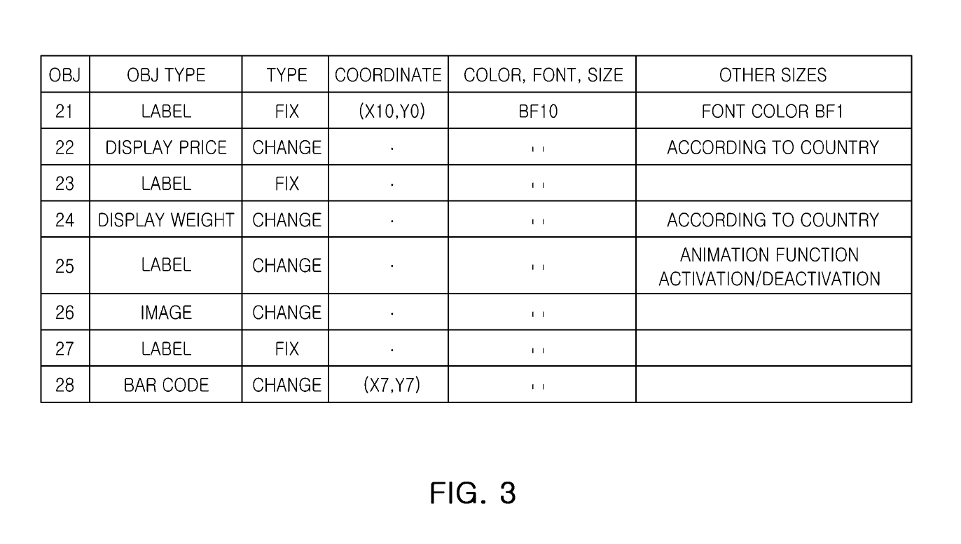

FIG. 3 shows an example of the layout information transmitted in a lower direction from the server 11 or the sync node device 12.

As shown in FIG. 3, the layout information is arranged in a table format that lists a format, a type, coordinates, and font color and size for each portion of the screen displayed on the price display of FIG. 2 and the arranged layout information may be transferred to a lower device.

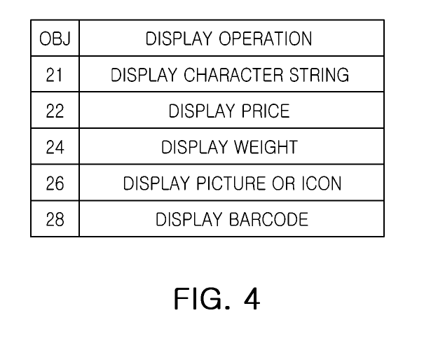

FIG. 4 shows an example of the display data of each display area shown in FIG. 3.

FIG. 3 shows the layout information and FIG. 4 shows the display data filled in the layout information.

Referring to FIG. 1 again, when the layout information and display data are transferred to the price display 13, the price display 13 updates the display unit (S15) and displays the received layout information and the display data filled therein.

Once the sync node device 12 and the price display 13 form the initial access, then the server 11 and the sync node device 12 do not transmit the layout information as shown in FIG. 2 and transmit only the display data to be changed.

That is, the server 11 transmits update information regarding the display data (‘update display data information’) to the sync node device 12 (S16), the sync node device 12 transmits the update display data information to the price display 13 (S17), and the price display 13 uses the received update display data information to update the display unit (S18), thereby correcting the screen displayed on the display unit of the price display.

As described above, in the exemplary embodiment of the present invention, the layout information is transmitted only when the communications device performs the initial communication, and in subsequent communications only changed information data is transmitted and only the transmitted information data is updated in the display unit.

Therefore, the exemplary embodiments of the present invention can reduce the data capacity transmitted and received between the communications devices and minimize the communication rate and the network traffic.

As set forth above, according to the exemplary embodiments of the present invention, the data capacity transmitted and received between the communications devices could be reduced and the communication rate and network traffic could be minimized. In particular, according to the exemplary embodiments of the present invention, the communication rate and the network load in transmitting and receiving the large-capacity data such as the multimedia data could be saved.

While the present invention has been shown and described in connection with the exemplary embodiments, it will be apparent to those skilled in the art that modifications and variations can be made without departing from the spirit and scope of the invention as defined by the appended claims.

What is claimed is:

1. A communications system for communicating display information, the communications system comprising:
a first communications device transmitting display information; and
a second communications device having a display unit displaying the display information,
wherein the display information includes display data and layout information as to where the display data is disposed, and
the first communications device transmits the layout information to the second communications device during an initial communication and transmits changed display data among the display data to the second communications device during subsequent communications after the initial communication.

2. The communications system of claim 1, wherein the layout information includes coordinate information displaying the display data.

3. The communications system of claim 2, wherein the layout information further includes at least one of a display format, fix/change or not, a font type, a font color, and a font size of the display data.

4. The communications system of claim 1, wherein the first communications device is a server or a sync node device of an electronic shelf label system, and
the second communications device is a price display of the electronic shelf label system.

5. A method for communicating display information including display data and layout information as to where the display data is disposed, the method comprising:
transmitting layout information and initial data of display data from a first communications device to a second communications device during an initial communication;
updating a display unit by allowing the second communications device to use the layout information and the initial data;
transmitting changed display data among the display data to the second communications device by the first communications device; and
updating the display unit by allowing the second communications device to reflect the changed display data.

6. The communications method of claim 5, wherein the layout information includes coordinate information displaying the display data.

7. The communications method of claim 6, wherein the layout information further includes at least one of a display format, fix/change or not, a font type, a font color, and a font size of the display data.

8. The communications method of claim 5, wherein the first communications device is a server or a sync node device of an electronic shelf label system, and
the second communications device is a price display of the electronic shelf label system.

9. An electronic shelf label system, comprising:
a server transmitting display information;
a sync node device receiving the display information from the server and determining whether the display information is display information to be transmitted to a subordinate node thereof; and
an electronic price display receiving the display information transmitted thereto as a designation from the sync node device,
wherein the display information includes display data and layout information as to where the display data is disposed, and
the server and the sync node device transmit the layout information during an initial communication and transmit changed display data among the display data during subsequent communications after the initial communication.

10. The electronic shelf label system of claim 9, wherein the layout information includes coordinate information displaying the display data.

11. The electronic shelf label system of claim 10, wherein the layout information further includes at least one of a display format, fix/change or not, a font type, a font color, and a font size of the display data.
